(19) United States
(12) Patent Application Publication
(10) Pub. No.: US 2025/0228647 A1
(43) Pub. Date: Jul. 17, 2025

(54) ORTHODONTIC TEETH-STRAIGHTENER MADE OF SHAPE-MEMORY POLYMERS, AND METHOD FOR THE PRODUCTION OF SAME

(71) Applicants: Fraunhofer-Gesellschaft zur Foerderung der Angwandten Forschung e.V., Muenchen (DE); Heinrich-Heine-Universitaet Duesseldorf, Duesseldorf (DE)

(72) Inventors: Dieter DRESCHER, Duesseldorf (DE); Thorsten PRETSCH, Potsdam-Golm (DE); Dennis SCHOENFELD, Potsdam-Golm (DE); Tobias RUEMMLER, Potsdam-Golm (DE)

(73) Assignees: Fraunhofer-Gesellschaft zur Foerderung der Angwandten Forschung e.V., Muenchen (DE); Heinrich-Heine-Universitaet Duesseldorf, Duesseldorf (DE)

(21) Appl. No.: 19/172,396

(22) Filed: Apr. 7, 2025

Related U.S. Application Data
(63) Continuation of application No. PCT/EP2023/077090, filed on Sep. 29, 2023.

(30) Foreign Application Priority Data
Oct. 5, 2022 (DE) 10 2022 125 583.2

(51) Int. Cl. A61C 7/08

(52) U.S. Cl. CPC A61C 7/08

(57) ABSTRACT

An orthodontic teeth-straightener, comprising a splint element which contains, or is entirely made from, a thermoplastic polyurethane having shape-memory properties. The thermoplastic polyurethane having shape-memory properties is selected from the group of polyether polyurethanes and contains hard segments which contain polyurethane units that have been obtained by polyaddition of the isocyanate groups of a diisocyanate to the hydroxyl groups of a diol acting as a chain extender, thereby forming urethane groups. The polyether polyurethane also contains soft segments, which contain, or are entirely made from, polyether units in the form of polyalkylene glycols, wherein the polyether units are bonded to isocyanate end groups of the diisocyanate of the hard segments, thereby forming urethane groups with the hard segments. The thermoplastic polyether polyurethane is both thermo-responsive and water-responsive and thus gives the splint element dual-stimuli responsive shape-memory properties.

This nonprovisional application is a continuation of International Application No. PCT/EP2023/077090, which was filed on Sep. 29, 2023, and which claims priority to German Patent Application No. 10 2022 125 583.2, which was filed in Germany on Oct. 5, 2022, and which are both herein incorporated by reference.

### BACKGROUND OF THE INVENTION

### Field of the Invention

The invention relates to an orthodontic teeth-straightener, comprising at least one splint element, which contains at least one thermoplastic polyurethane having shape-memory properties, at least in regions, or is made essentially entirely therefrom. The invention also relates to methods for manufacturing a splint element of an orthodontic teeth-straightener of this type.

### Description of the Background Art

Orthodontic treatment methods used to eliminate malocclusions are generally based on a tooth movement therapeutically induced with the aid of different types of, usually essential splint-shaped, teeth-straightener, the orthodontic tooth movement being initiated by sustained application of forces and/or moments. After applying the orthodontic force system, the teeth are deflected within the tooth sockets during their physiological tooth movement. This directly induces hemodynamic circulatory disturbances in the periodontal space. Local ischemias or hemostases result in the region of the pressure points, which can generate localized micronecroses of the periodontal tissue. The lack of blood supply results in a sterile inflammatory response, which, over the course of approximately 2 to 3 weeks, induces a proliferation of the osteoclasts and osteoblasts responsible for bone remodeling. In addition to the hemodynamic inflammatory response, piezoelectric surface potentials occur due to the deformation of the hydroxylapatite embedded in the bone, which changes the permeability of the cell membranes. The numerous fibroblasts occurring in the periodontal space, in particular, undergo a deformation of the cytoskeleton, due to the membranous integrins. Intracellular signal chains are activated in this way, which result in the expression of specific cytokines. These described processes induce the orthodontic tissue remodeling, which makes it possible to correct malocclusions.

The forces generated by an orthodontic teeth-straightener should, on the one hand, not be too low in order to result in a change in the tooth position, while, on the other hand, certain maximum values should not be exceeded, because the periodontal tissue can otherwise become irreversibly damaged, which may even be associated with a tooth loss. For this reason, horizontal tooth movements are usually effectuated using forces of approximately 0.5 N to approximately 2 N and/or using moments of approximately 3 Nmm to approximately 20 Nmm. In this way, the teeth may be moved at a speed of approximately 1 mm to 2 mm per month.

Inducing a therapeutic tooth movement with fixed orthodontic teeth-straightener in the form of so-called multibracket appliances are still the main treatment for correcting malocclusions in a wide range of modifications. Since the brackets are usually fastened to the outside of the teeth, they are perceived as aesthetically compromising not only by the growing group of adult patients, but increasingly also by adolescents. Efforts have subsequently been made to make the treatment as invisible as possible. This resulted in the development of aesthetic alternatives and the creation of a new market segment within the orthodontic product range, so-called “invisible orthodontic appliances.” Market relevant approaches cover brackets made from ceramics, brackets on the inside of the tooth, as well as, in particular, so-called aligners, which are used to treat malocclusions.

Compared to the fixed brackets, which are therefore often felt to be unpleasant on the part of the patient, the so-called aligner therapy has the advantage that it makes do with a plurality of individually produced splints made from plastic materials, which may be preferably manufactured to be transparent and consequently largely invisible and may also be removed and inserted by the patient as needed. The splints, i.e., the so-called aligners, may be produced, for example, with the aid of modern CAD (computer-aided design) or CAM (computer-aided manufacturing) technologies, during which any tooth positions or dental arches may be transferred to three-dimensional models before being corrected, for example using thermoplastic deep-drawing films. However, the intended tooth movements must be implemented in a multiplicity of setup steps, so-called staging, using a large number of models per dental arch, usually between approximately 30 and approximately 90, in which the current tooth position of the patient must always be taken into account. In technical terms, this is implemented by producing individual splints, in particular during the deep-drawing process, the splints not being produced in a precisely fitting manner but in such a way that they apply a therapeutically desired pressure to the particular teeth. In clinical practice, this results in a plurality of relatively small, “preprogrammed” tooth position changes during the individual therapy steps, with tooth movements in each case of approximately 0.1 mm to approximately 0.25 mm (translational) and/or in each case of up to approximately 3° (rotational) during a patient-recommended wearing period of approximately one to three weeks in each case.

At present, polyethylene vinyl acetates and polyethylene terephthalate glycol (PET-G) in layer thickness of approximately 0.5 mm to approximately 1.5 mm have become established as standard materials for the aligner therapy. However, films of this type, including the methods used for their production, have some serious disadvantages. Relatively high mechanical strengths of the splints thus occur, in particular during the deep-drawing process, based on geometric effects, which limit the later deflection range of the film, in part to a considerable extent. This results, on the one hand, in an only limited change in position by which a tooth may be moved during a setup step. On the other hand, the generation of initial, unphysiologically high (compressive) forces may occur due to the high strengths of the splints, despite a reduction in the setup steps to, for example, approximately 0.1 mm to approximately 0.2 mm per tooth, which may result in the patient feeling a high pressure on the teeth to be moved during the insertion of the film-like splint. Biomechanical studies that dealt with the effects of the setup steps and the influence of the thickness of aligner film on the transferred forces and moments on the teeth also conclude that the setup steps recommended up to now can also result in the development of unphysiologically high forces and moments even for the thinnest commercially available films having a thickness of approximately 0.5 mm (cf., for example, Hahn W, Fialka-Fricke J, Dathe H, Fricke-Zech S, Zapf A, Gruber R, et al: “Initial Forces Generated by Three Types of Thermoplastic Appliances on an Upper Central Incisor During Dipping,” European Journal of Orthodontics, 2009, 31:625-631).

The aforementioned type of polymers used for the aligners usually undergo a linear increase in force in the region of the elastic deformation and thus also within the scope of the rebound, which effectuates the actual tooth movement. If a splint is therefore inserted into the patient, very high stresses occur, followed by a rapid drop in force. For example, a film made from polyethylene terepthalate glycol (PET-G) which is approximately 0.5 mm thick generates forces of approximately 2.27 N to approximately 5.31 N when a maxillary anterior tooth is labially or lingually displaced by 0.25 mm. Conversely, thicker films made from PET-G having a thickness of approximately 0.8 mm result in even higher forces between approximately 5.2 N and approximately 7.22 N (cf., for example, Elkholy F, Panchaphongsaphak T, Kilic F, Schmidt F, Lapatki BG: “Forces and Moments Delivered by PET-G Aligners to an Upper Central Incisor for Labial and Palatal Translation,” Journal of Orofacial Orthopedics/Fortschritte der Kieferorthopädie (Advances in Orthodontics): Institution/Official Journal of the German Orthodontics Society (Deutsche Gesellschaft für Kieferorthopädie), 2015, 76:460-475)). However, the recommended force for this tooth movement is only approximately 0.35 N to approximately 0.6 N (cf., for example, Proffit WR, Fields Jr. HW, Sarver DM: “Contemporary Orthodontics,” Elsevier Health Sciences, 2006) and consequently underscores the need to reduce the forces applied to the patient's teeth and thus to implement alternative solution concepts. In the case of greater displacements beyond approximately 0.15 mm, for example, the splint strength also has an enormous impact, the forces and moments even increasing significantly.

Due to the excessively high forces, pronounced hyalinization phases occur in the periodontal apparatus during the metabolic processes induced there for initiating the tooth movement, which may even result in a standstill—a so-called cessation—of the tooth movement (cf., for example, Barbagallo L J, Jones A S, Petocz P, Darendeliler M A: “Physical Properties of Root Cementum: Part 10. Comparison of the Effects of Invisible Removable Thermoplastic Appliances with Light and Heavy Orthodontic Forces on Premolar Cementum. A Microcomputed-Tomography Study,” American Journal of Orthodontics and Dentofacial Orthopedics, 2008, 133:218-227). The histological phenomenon of hyalinization occurs due to excessive compression in the region of the periodontal apparatus or periodontal space. The vessels in the periodontal space are compressed, blood flow is suppressed and disrupted, and the cell response of the tissue for remodeling the bone is slowed down. A slowdown or even an absence of tooth movement may subsequently occur. A further consequence of (excessively) high forces lies in the increased risk of irreversible pathological root resorptions.

The objective of a comparative split mouth study was to examine the occurrence of root resorptions when using aligners and fixed orthodontic appliances, so-called brackets, during the buccal tipping of bicuspids by 0.3 mm (cf. the above citation). The study was able to establish root resorptions (irreversible loss of dental substance at the root tip) that were greater in the aligner group than in the bracket group. To allow tooth movements to progress in a physiological framework, low and constant forces, in particular, have therefore proven to be particularly suitable. With regard to the quality of the results in treating malocclusions with the aid of aligners, studies have clearly demonstrated the deficits of the currently commercially available systems. According to the current state of knowledge, the effectiveness of the tooth movement with the aid of aligners therefore appears to be still insufficient. Moreover, findings of studies from in the field of lingual orthodontics (cf., for example, Pauls AH: “Therapeutic Accuracy of Individualized Brackets in Lingual Orthodontics,” Journal of Orofacial Orthopedics/Fortschritte der Kieferorthopädie (Advances in Orthodontics): Institution/Official Journal of the German Orthodontics Society (Deutsche Gesellschaft für Kieferorthopädie), 2010, 71:348-361) have shown that the accuracy of the results of aligner orthodontics have also proven to be in need of improvement. The commercially available aligner films have small activation ranges, so that only small setup steps are possible for programming the tooth movement. From an economic standpoint, this results in a greater material use and rejects, since reducing the size of the setup steps means that more dental arch models need to be printed and more splints processed in the deep-drawing process, an average of 50 to 90 setup steps being needed for correction, as mentioned above, depending on the severity of the malocclusion. A material having a larger active working range would promise to have an influence on the number of setup steps and thus bring about sustained savings in the manufacture of aligners, by which means it should also be possible to lower the average treatment costs. Due to the need to improve the quality of the results, further corrections of the tooth positions, so-called refinements, are also necessary in some cases, which can further increase treatment costs.

In recent years, the use of so-called shape-memory polymers is assumed to have great potential for the splint element used in aligner therapy when it comes to decreasing the number of necessary setup steps and thus reducing the amount of labor involved as well as with regard to the application of more or less constantly lower forces to the user's teeth. Shape-memory polymers of this type are polymers which are usually made up of two polymer components or, in particular, of one polymer component having different segments. These are, on the one hand, hard segments which act as network points and, on the other hand, soft segments which interconnect the network points and are also referred to as switching segments, which are elastic at high temperatures (in this case, they are in an amorphous form), while they are rigid at low temperatures (in this case, they are in a semi-crystalline or vitrified form). Shape-memory polymers of this type may be programmed with respect to their shaping, in that they are heated to a temperature corresponding at least to the so-called switching temperature, at which the phase transition (glass transition or melting transition) of the soft or switching segments takes place. At such a temperature, the polymer is then deformed, after which it is cooled at least to its so-called shape-fixing temperature, maintaining the deformation forces, which corresponds to the glass transition temperature of the soft or switching segments and may be in the range of the switching temperature, although it is usually at least slightly lower. The soft or switching segments are then in semi-crystalline or vitrified form again, so that the shaping is maintained. However, this shaping is only temporary to the extent that, when a mechanically deformed shape-memory polymer “programmed” in this way is heated to a certain temperature, namely its switching temperature, the soft segments (switching segments) return to their amorphous shape, so that they can no longer counteract the restoring force induced by the hard component (network points), and the shape-memory polymer takes on its original shape again, thus “reversing” the mechanical deformation.

In addition to a shape-memory of this type, thermo-responsive shape-memory polymers also have a temperature memory, which is understood to mean that, upon triggering the shape-memory effect, the shape recovery sets in, for example at the temperature at which the mechanical deformation was previously introduced into the polymer material. For example, polymers having semi-crystalline network structures, such as thermoplastic polyurethane elastomers, have a material behavior of this type (cf., for example, N. Fritzsche, T. Pretsch in Macromolecules 47, 2014, 5952-5959; N. Mirtschin, T. Pretsch in RSC Advances 5, 2015, 46307-46315).

The basic principle in using shape-memory polymers of this type for splint elements used in aligner therapy is that, following a thermomechanical pretreatment, so-called programming, the shape-memory polymers react to temperature changes, so that they are able to release forces in a predefined manner (cf., for example, Pretsch T, Müller W.: “Shape Memory Poly(ester Urethane) with Improved Hydrolytic Stability,” Polym Degrad Stab, 2010, 95:880-888; Mya K Y, Gose H B, Pretsch T, Bothe M, He C: “Star-Shaped POSS-Polycaprolactone Polyurethanes and Their Shape Memory Performance,” J Mater Chem, 2011, 21:4827-4836; Fritzsche N, Pretsch T: “Programming of Temperature Memory Onsets in a Semicrystalline Polyurethane Elastomer,” Macromolecules, 2014, 47:5952-5959, Mirtschin N, Pretsch T: “Designing Temperature-Memory Effects in Semicrystalline Polyurethane,” RSC Adv, 2015, 5: 46307-46315, Mirtschin N, Pretsch T: “Programming of One- and Two-Step Stress Recovery in a Poly(ester Urethane),” Polymers, 2017, 9:98 (12 pages)). These forces may generally be used to implement controlled tooth movements.

US 2005/0003318 A1 describes a splint element of an orthodontic treatment in the form of an aligner splint made up of a film manufactured from shape-memory polymers, which is produced from a negative impression of the patient's teeth. This is done in such a way that the shape of the splint is programmed onto the setpoint state of the tooth position, after which it is deformed to the actual state of the tooth position by heating it to the switching temperature of the shape-memory polymer. The switching temperature of the shape-memory polymer is in the range of the human body temperature, so that the splint may deform back into the setpoint state in the patient's oral cavity without applying excessive pressure to the patient's teeth. A similar aligner splint results from U.S. Pat. No. 8,758,009 B2, the film used for the splint in this case being constructed in multiple layers from shape-memory polymers, so that each layer may be programmed individually and apply a certain force to the user's teeth during its shape recovery. A further orthodontic teeth-straightener, including a splint element made from shape-memory polymers, is known from DE 10 2017 009 287 B4. The splint element in this case comprises multiple fastening devices arranged at a distance from each other, which are each detachably fastened to a carrier attachable to a patient's tooth, the relative arrangement of the at least two fastening devices being variable due to the change in shape of the shape-memory polymer. A plurality of shape-memory polymers to be used for orthodontic purposes are apparent from US 2006/0154195 A1, the teeth-straightener produced herefrom being intended to be used primarily as additional components of conventional splints or brackets for the purpose of generating local pressure between different regions thereof. WO 2017/079157 A1 furthermore deals with aligner splints made from semi-crystalline shape-memory polymers, which have a switching temperature in the range of the human body temperature.

DE 10 2015 108 848 A1 describes an orthodontic teeth-straightener, including a splint element made from a thermoplastic polymer mixture, which is not specified in greater detail and which contains shape-stable polymers, on the one hand, and polymers having water-responsive properties, on the other hand. The splint element is to be produced in an initial shape by means of thermoplastic processing method according to an actual dental arch model, it being deformed into a later shape according to a setpoint dental arch model when it comes into contact with water, including saliva. The shape corresponding to the setpoint dental arch model is to be calculated in a manner, which is also not specified in greater detail, taking into account the shape and the wall thickness of the splint element as well as the shape changing capacity of the water-responsive polymer share.

### SUMMARY OF THE INVENTION

It is therefore an object of the invention to easily and cost-effectively refine an orthodontic teeth-straightener suitable for the aligner therapy, which includes at least one splint element based on thermoplastic polymers having shape-memory properties of the type mentioned at the outset, such that an exact tooth movement may be induced using a plurality of setup steps, while at least largely avoiding the aforementioned disadvantages, without applying unphysiologically high forces to the patient's teeth. It is also directed to methods for manufacturing a splint element of an orthodontic treatment of this type.

In the case of an orthodontic teeth-straightener, the first part of the object is achieved according to the invention in that the at least one thermoplastic polyurethane having shape-memory properties of the splint element is selected from the group of polyether polyurethanes and contains hard segments containing polyurethane units which have been obtained by polyaddition of the isocyanate groups of at least one diisocyanate to the hydroxyl groups of at least one diol acting as a chain extender, forming urethane groups; as well as soft segments which contain or are made entirely from polyether units in the form of at least one polyalkylene glycol, the polyether units being bonded to isocyanate end groups of the at least one diisocyanate of the hard segments, forming urethane groups with the hard segments, the thermoplastic polyether polyurethane being thermo-responsive as well as water-responsive.

In terms of processing engineering, to achieve this object, a first aspect provides a method for manufacturing a splint element of an orthodontic teeth-straightener of the type mentioned at the outset, which comprises the following steps: (a) providing at least one film, which contains at least one thermoplastic polyurethane having shape-memory properties, at least in regions, or is formed essentially entirely therefrom, the thermoplastic polyurethane having shape-memory properties being selected from the group of polyether polyurethanes and containing hard segments containing polyurethane units which have been obtained by polyaddition of the isocyanate groups of at least one diisocyanate to the hydroxyl groups of at least one diol acting as a chain extender, forming urethane groups, as well as soft segments which contain or are made entirely from polyether units in the form of at least one polyalkylene glycol, the polyether units being bonded to isocyanate end groups of the at least one diisocyanate of the hard segments, forming urethane groups with the hard segments, the thermoplastic polyether polyurethane being thermo-responsive as well as water-responsive; (b) Overmolding the at least one film onto a setpoint dental arch model, forming a splint element, which is in a permanent shape of the thermoplastic polyether polyurethane having shape-memory properties; (c) Heating the splint element according to step (b) at least to the switching temperature of the thermoplastic polyether polyurethane having shape-memory properties and overmolding the splint element onto an actual dental arch model or onto a human dental arch, after which the splint element is cooled in a temporary shape at least to the shape-fixing temperature of the thermoplastic polyether polyurethane; or Immersing the splint element according to step (b) in water or into an aqueous solution and overmolding the splint element onto an actual dental arch model or onto a human dental arch, after which the splint element is dried in a temporary shape; and (d) Removing the splint element in the temporary shape from the actual dental arch model or from the human dental arch.

According to a second aspect, to achieve this object in terms of process engineering, the invention provides a method for manufacturing a splint element of an orthodontic teeth-straightener of the type mentioned at the outset, which comprises the following steps: (a) generating a three-dimensional model of the splint element according to a setpoint dental arch model; (b) feeding the three-dimensional model of the splint element into a 3D printer; (c) fused deposition modeling the splint element in a permanent shape with the aid of the 3D printer, using at least one printing filament or granulate made from a thermoplastic polymer material which contains at least one thermoplastic polyurethane having shape-memory properties or is formed essentially entirely therefrom, the thermoplastic polyurethane having shape-memory properties being selected from the group of polyether polyurethanes and containing hard segments containing polyurethane units which have been obtained by polyaddition of the isocyanate groups of at least one diisocyanate to the hydroxyl groups of at least one diol acting as a chain extender, forming urethane groups, as well as soft segments which contain or are made entirely from polyether units in the form of at least one polyalkylene glycol, the polyether units being bonded to isocyanate end groups of the at least one diisocyanate of the hard segments, forming urethane groups with the hard segments, the thermoplastic polyether polyurethane being thermo-responsive as well as water-responsive; (d) heating the splint element according to step (c) at least to the switching temperature of the thermoplastic polyether polyurethane having shape-memory properties and overmolding the splint element onto an actual dental arch model or onto a human dental arch, after which the splint element is cooled in a temporary shape at least to the shape-fixing temperature of the thermoplastic polyether polyurethane; or immersing the splint element according to step (c) in water or into an aqueous solution and overmolding the splint element onto an actual dental arch model or onto a human dental arch, after which the splint element is dried in a temporary shape; and (e) removing the splint element in the temporary shape from the actual dental arch model or from the human dental arch.

As is known per se in aligner splints made from shape-memory polymers according to the prior art, the invention is based on the fact that polymers having thermo-responsive shape-memory properties may be easily transferred by thermomechanical treatment, also known as “programming,” from a permanent shape into a thermo-responsive state of a temporary shape, in which they remain until they are again heated at least to their switching temperature. The splint element of the teeth-straightener according to the invention, whose total thickness is advantageously between approximately 500 μm and approximately 3 mm, may therefore be temporarily stabilized in a deformed state (corresponding to the actual state of the patient's tooth position) by means of a corresponding programming and is oriented toward the patient's current tooth position, after which the splint element returns to its previously programmed shape (corresponding to the setpoint state of the patient's tooth position) upon being heated at least to the switching temperature of the polymer having shape-memory properties and/or having thermo-responsive properties. Due to the material of the splint element made from the at least one polyether polyurethane according to the invention having shape-memory properties, the change in shape of this polymer is thus variable, it being able to be programmed, however, not only from the actual state of the patient's tooth position to the setpoint state of a particular setup step, but also to the setpoint state of a plurality of setup steps, which are then triggered individually little by little by briefly heating multiple times to the switching temperature range, in order to achieve an only partial shape recovery (corresponding to one setup step) in each case until the programmed shape change has been completely reversed, and the splint element is again in its permanent shape according to the originally programmed setpoint tooth position. This may be achieved, for example, in that a particular shape recovery of the splint element is carried out just under or in the lower range of the onset of the glass transition temperature of the soft segments made from polyalkylene glycol units, i.e., at the lower end of the switching temperature range, during a particular setup step, until, in a final setup step, the splint element is heated at or above the upper range of the offset of the glass transition temperature of the soft segments of the polyether polyurethane to ensure a “final” practically complete shape recovery. In this way, one and the same splint element may be used according to the multiple setup steps over a longer treatment period, and excessive compressive and/or tensile forces acting upon the user's teeth may be reliably avoided, since it is possible to select practically any small size of the individual setup steps.

It has moreover been proven to be particularly advantageous that the soft segments of the thermoplastic polyether polyurethane having shape-memory properties are formed according to the invention from polyalkylene glycols, which lend the polyether polyurethane not only thermo-responsive shape-memory properties of the type mentioned above, but also a water responsivity. In the case of longer contact with water or the user's saliva, the polyalkylene glycol units of the soft segments for their part are able to ensure a moderate shape recovery capacity of the splint element from its temporary shape (corresponding to the programmed actual state of the dental arch) into its permanent shape (corresponding to the setpoint state of the dental arch upon the conclusion of the orthodontic treatment step), so that, when the splint element is worn by the user, a more or less continuous rebound of the splint element “in the direction” of its permanent shape takes place during one and the same setup step, in this way preventing excessively high forces from acting upon the user's dental arch. The share of the shape recovery of the splint element due to its water responsivity may also be controlled by the user within certain limits, in that he/she places the splint element in water or in an aqueous cleaning solution, for example overnight, the shape recovery being more pronounced the higher the temperature of the water, i.e., the closer the water temperature is to the switching temperature of the thermoplastic polyether polyurethane having shape-memory properties, and/or the longer the splint element is in contact with water. The thermoplastic polyether polyurethane according to the invention having shape-memory properties of the splint element is, of course, not water-soluble, nor is it a hydrogel, but instead its shape-memory effect is based—as mentioned above—on the glass transition of the soft segments, which contain or are made from polyether units based on polyalkylene glycols.

The thermoplastic polyether polyurethane according to the invention, which includes soft segments made from polyalkylene glycol units, thus lends the splint element of the orthodontic treatment dual stimuli-responsive properties, in that, on the one hand, it is programmable in a manner similar to conventional shape-memory polymers, while, on the other hand, a—complete or, in particular successive—shape recovery is triggered by heating to the switching temperature range once or, in particular, multiple times and also as a result of contact with water, i.e., it is both thermo-responsive and water-responsive.

In addition, the manufacture of the splint element of the orthodontic treatment is relatively easy and cost-effective:

According to an example of the manufacturing method according to the invention, in a first step (a), at least one film may be initially provided which may be produced by any thermoplastic processing method, such as extrusion, injection molding, hot pressing, or the like, and which contains at least one thermoplastic, thermo-responsive, as well as water-responsive polyurethane having shape-memory properties of the type mentioned above or is formed essentially entirely therefrom, at least in regions. Instead of a single film, a film composite may also be provided, made up of multiple films, for example from the same or also from different thermoplastic polymers, for example film composites made from different polyether polyurethanes according to the invention having shape-memory properties may be used, or also film composites, in which only one or multiple film layer(s) are formed from shape-memory polymers of this type, for example to be able to adapt the switching temperature, the shape recovery behavior, etc. to the particular application purpose in a targeted manner.

In a step (b), the film may be over molded onto a setpoint dental arch model, which may be done, for example, by means of deep drawing in a molten state of the thermoplastic polymer material of the splint element. A corresponding splint element in a permanent shape of the thermoplastic polyether polyurethane having shape-memory properties, which corresponds to the tooth position upon the conclusion of a (particular) orthodontic treatment step, may then be obtained by cutting off the edges of the film.

During the programming of the splint element into a temporary shape according to the actual tooth position, in a subsequent step (c), the splint element may, on the one hand, be heated at least to or even past the switching temperature of the thermoplastic polyether polyurethane having shape-memory properties and overmolded onto an actual dental arch model or onto a human dental arch for the purpose of molding it mechanically into its temporary shape. By continuously overmolding it onto the actual dental arch model or onto the human dental arch, the splint element may be finally cooled in its temporary shape at least to the shape-fixing temperature of the thermoplastic polyether polyurethane or preferably to a temperature below the same. This concludes the programming, after which the finally programmed splint element, which is in its temporary shape, may be removed from the actual dental arch model or the human dental arch in a final step (d).

Due to the water responsivity of the thermoplastic polyether polyurethane having shape-memory properties of the splint element according to the invention according to step (c), during the programming the latter may instead be immersed in water or in an aqueous solution over a sufficient period of time for the purpose of transferring the soft segments of the polyether polyurethane into a glass-like state in which they are plastically deformable. The water temperature may be set below the switching temperature of the polyether polyurethane. The splint element pretreated in this manner may then be again overmolded onto an actual dental arch model or onto a human dental arch, after which the splint element is dried in a temporary shape (the soft segments are then able to withstand the deformation of the splint element in its temporary shape). The latter may take place, for example, by exposure to ambient air over a sufficient period of time or, if desired to accelerate the drying process, in a drying chamber or the like.

This concludes the programming, after which the finally programmed splint element, which is in its temporary shape, may be removed from the actual dental arch model or the human dental arch in a final step (d).

According to a second design variant of the manufacturing method according to the invention, the splint element of the orthodontic teeth-straightener may also be produced, in particular, by means of fused deposition modeling, in that the at least one thermoplastic polyether polyurethane having shape-memory properties of the type described above is plasticized and deposited in layers with the aid of at least one nozzle of a print head of a 3D printer, which is movable in a controlled manner, forming the splint element in its permanent shape. Such fused deposition modeling (FDM) methods, also known as fused filament fabrication (FFF) or freeforming, using 3D printers are known per se and are manufacturing methods in which one or multiple filament(s) or granulates made from thermoplastic polymers is/are plasticized in a plasticizing unit of the 3D printer and deposited in layers with the aid of an outlet nozzle usually provided in the print head of the 3D printer for the purpose of producing the splint element ultimately formed from a multiplicity of layers or “droplets” of this type. During the fused deposition modeling with the aid of 3D printing, which is also referred to as additive manufacturing, a three-dimensional model of the splint element to be produced is usually generated digitally, which may take place, in particular, using the known methods of computer-aided design (CAD). In addition, the three-dimensional model of the splint element to be produced is divided into a plurality of thin layers with the aid of suitable software, for example a so-called slicer program (e.g., Cura™ or the like), after which the plasticized polymer is deposited in layers with the aid of the outlet nozzle of the correspondingly moved print head for the purpose of building the splint element layer by layer. Immediately after the deployment of the polymer melt discharged from the outlet nozzle of the print head in a more or less filament-shaped or droplet-shaped manner, the curing process—or, more specifically, the solidification process—begins, the deposited polymer melt solidifying, for example, at ambient temperature or also by active cooling (cf., for example, DE 10 2018 003 273 A1, which is incorporated herein by reference).

According to the second example of the manufacturing method according to the invention, it may therefore be provided that a three-dimensional model of the splint element is initially generated in electronic form according to a setpoint dental arch model in a step (a) and fed into the control software of a 3D printer in a step (b). In a subsequent step (c), the fused deposition modeling of the splint element in its permanent shape takes place with the aid of the 3D printer, at least one printing filament or at least one printing granulate being used, which is made from at least one thermoplastic polyether polyurethane having shape-memory properties of the type described above. In this connection, it is also in other respects conceivable that the splint element is printed onto a core or a support structure made from another, not necessarily polymer, material by means of fused deposition modeling.

During the programming of the splint element into a temporary shape according to the actual tooth position, in a subsequent step (d), the splint element may again be heated either at least to or even past the switching temperature of the thermoplastic polyether polyurethane having shape-memory properties, and the splint element is overmolded onto an actual dental arch model or onto a human dental arch for the purpose of deforming it mechanically into its temporary shape. By continuously overmolding it onto the actual dental arch model or onto the human dental arch, the splint element is finally cooled in its temporary shape at least to the shape-fixing temperature of the thermoplastic polyether polyurethane or preferably to a temperature below the same. This concludes the programming, after which the finally programmed splint element, which is in its temporary shape, may be removed from the actual dental arch model or the human dental arch in a final step (e).

In this case as well, the splint element may alternatively be immersed in water or in an aqueous solution over a sufficient period of time during the programming according to step (d) for the purpose of transferring the soft segments of the polyether polyurethane into a glass-like state in which they are plastically deformable. As mentioned above, the water temperature may be set below the switching temperature of the polyether polyurethane. The splint element pretreated in this manner may then be again overmolded onto an actual dental arch model or onto a human dental arch, after which the splint element is dried in a temporary shape (the soft segments are then able to withstand the deformation of the splint element in its temporary shape). The latter may take place, for example, by exposure to ambient air over a sufficient period of time or, if desired to accelerate the drying process, in a drying chamber or the like.

This concludes the programming, after which the finally programmed splint element, which is in its temporary shape, may be removed from the actual dental arch model or the human dental arch in a final step (e).

The polyalkylene glycol of the polyether units of the soft segments of the thermoplastic polyether polyurethane according to the invention having shape-memory properties, which lend the splint element both thermo-responsive and water-responsive properties, is preferably a polyalkylene glycol whose monomeric alkylene glycols have between 2 and 5 carbon atoms, in particular polyethylene glycol (PEG) and/or polypropylene glycol (PPG), and/or polytetramethylene ether glycol (PTMEG, polytetrahydrofuran).

Moreover, the polyether units of the soft segments of the thermoplastic polyether polyurethane, which are formed by polyalkylene glycol units, preferably have an average molar mass of at least approximately 250 g/mol, in particular at least approximately 300 g/mol, preferably at least 350 g/mol, e.g., at least approximately 400 g/mol, to ensure pronounced thermo-responsive as well as water-responsive properties of the polyether polyurethane having shape-memory properties. It may furthermore be advantageously provided that the polyether units of the soft segments of the thermoplastic polyether polyurethane, which are formed by polyalkylene glycol units, have an average molar mass of no more than approximately 2,000 g/mol, in particular no more than approximately 1,600 g/mol, in particular no more than approximately 1,200 g/mol, e.g., no more than approximately 1,000 g/mol, so that the splint element may be designed to be transparent to the greatest possible extent for aesthetic reasons.

It may furthermore be provided in an example that the switching temperature of the thermoplastic polyether polyurethane corresponding to the glass transition temperature of the polyether units of the soft segments of the thermoplastic polyether polyurethane, which are formed by polyalkylene glycol units, may be more than approximately 37° C., in particular at least approximately 38° C., preferably at least approximately 40° C., e.g., at least approximately 45° C. or at least approximately 50° C., in particular to prevent an unintentional shape recovery of the splint element beyond that of a particular setup step from occurring as a result of the body temperature of the user. It has similarly been proven to be advantageous if the switching temperature is noticeably higher compared thereto and is, for example, approximately 60° C., so that an unintentional shape recovery of the splint element is not triggered, for example if it is cleaned in warm water by the user.

It has, however, been proven to be advantageous if the switching temperature is no more than approximately 100° C., in particular no more than approximately 90° C., preferably no more than approximately 80° C., so that a targeted shape recovery may be—either partially or essentially entirely—effectuated at relatively moderate temperatures during a particular setup step, for example by corresponding heating of the splint element in warm or hot liquid, such as water or the like.

To ensure pronounced thermo-responsive and water-responsive shape-memory properties of the splint element, it has furthermore been proven to be advantageous if the share of the polyether units of the soft segments formed by the polyalkylene glycol units is between approximately 10 mass % and approximately 80 mass %, in particular between approximately 20 mass % and approximately 70 mass %, preferably between approximately 30 mass % and approximately 60 mass %, e.g., between approximately 35 mass % and approximately 50 mass %, in relation to the total mass of the thermoplastic polyether polyurethane.

It may be provided that the at least one diisocyanate, from which the polyurethane units of the hard segments of the thermoplastic polyether polyurethane having shape-memory properties have been obtained, can be selected from the group of aromatic, aliphatic, or cycloaliphatic diisocyanates, in particular from the group of isomers or isomer mixtures of the methylene diphenyl diisocyanates (MDI), 1,6-hexamethylene diisocyanate (HDI), 4,4′-diisocyanato dicyclohexylmethane (H₁₂MDI), isomers or isomer mixtures of the toluene diisocyanates (TDI), 1,5-pentamethylene diisocyanate (PDI), isophorone diisocyanate (IPDI), naphthalene diisocyanate (NDI), and polymeric methylene diphenyl diisocyanate (PMDI), including mixtures thereof.

The at least one diol acting as a chain extender, from which the polyurethane units of the hard segments of the thermoplastic polyether polyurethane having shape-memory properties have been obtained, may preferably be selected from the group of alkane diols, in particular from the group of ethanediol (ethylene glycol), 1,3-propanediol (propylene glycol), 1,4-butanediol, 1,5-pentanediol, 3-methyl-1,5-pentanediol, 1,6-hexanediol, 1,7-heptanediol, 1,8-octanediol, 2-methyl-1,8-octanediol, 1,9-nonanediol, 1,10-decanediol, 1,11-undecanediol, and 1,12-dodecanediol, including mixtures thereof.

The hard segments of the thermoplastic polyether polyurethane according to the invention having both thermo-responsive and water-responsive shape-memory properties of the splint element may therefore be advantageously composed of at least one aromatic, aliphatic or cycloaliphatic diisocyanate, such as isomers or isomer mixtures of the methylene diphenyl diisocyanates (MDI), isophorone diisocyanate (IPDI), 1,6-hexamethylene diisocyanate (HDI), 4,4′-diisocyanato dicyclohexyl methane (H₁₂MDI), isomers or isomer mixtures of the toluene diisocyanates (TDI), 1,5-pentane diisocyanate (PDI), or mixtures thereof, and at least one diol acting as a chain extender. The diols acting as chain extenders may be generally known dihydroxy compounds, in particular ethanediol (ethylene glycol), 1,3-propanediol, 1,4-butanediol, 1,5-pentanediol, 3-methyl-1,5-pentanediol, 1,6-hexanediol, 1,7-heptanediol, 1,8-octanediol, 2-methyl-1,8-octanediol, 1,9-nonanediol, 1,10-decanediol, 1,11-undecanediol, and 1,12-dodecanediol, including mixtures thereof, being considered, so that thermoplastic polyether polyurethane having shape-memory properties do not have any cytotoxicity according to the DIN EN ISO 10993-5-2009-10 standard. Moreover, additional chain extenders based on diamine compounds may possibly be used. The possible diamine compounds include, for example, isophorone diamine, ethylenediamine, 1,2-propylenediamine, 1,3-propylenediamine, N-methylpropylene-1,3-diamine, N,N′-dimethylethylenediamine, as well as aromatic diamines, such as 2,4-toluenediamine, 2,6-toluenediamine, 3,5-diethyl-2,4-toluendiamine, and 3,5-diethyl-2,6-toluenediamine, or primary mono-, di-, tri- or tetraalkyl-substituted 4,4′-diaminodiphenylmethanes, including mixtures thereof.

Aminoalcohols, such as N-2 (methylamino) ethanol or 3-(methylamino)-I-propanol and the like, may be considered as additional chain extenders. Additional chain extenders of this type may be used both individually in combination with the at least one diol and in any mixture with each other as well as with the at least one diol. However, such diamines would not be suitable as sole chain extenders, since, in contrast to the polyether polyurethane according to the invention, the resulting polyureas would not be able to be thermoplastically processed and would also have insufficient shape-memory properties.

The thermoplastic polyether polyurethane according to the invention having shape-memory properties of the splint element consequently contains hard segments, which contain polyurethane units which have been obtained by polyaddition of the isocyanate groups (—N═C═O groups) of the at least one diisocyanate to the hydroxyl groups (—OH groups) of the at least one diol acting as a chain extender with the isocyanate groups, forming urethane groups (—NH—CO—O—). However, the thermoplastic polyether polyurethane according to the invention also contains soft segments, which contain polyether units in the form of polyalkylene glycol units, the polyether units being bonded to the to the isocyanate groups of the at least one diisocyanate of the hard segments by polyaddition of corresponding (poly)alkylene glycols, forming urethane groups with the hard segments.

It may furthermore be provided that the at least one polyether polyurethane having shape-memory properties of the splint element can contain at least one additive, which may be selected, in particular, from the group of biocompatible oils, electromagnetic radiation-absorbing fillers, inductively heatable fillers, colorants and pigments, as well as reinforcing fibers.

While additives in the form of biocompatible oils, for example silicone oil and the like, are able to improve the biological compatibility of the polymer material of the splint element, it is possible by adding further additives present, in particular, in the form of fillers, to set the mechanical, electrical, magnetic, and/or optical properties of shape-memory polymers and adapt them to the particular application purpose, it being possible, in particular, to also modify the shape-memory properties themselves, such as, in particular, the recovery rate and/or the recovery temperature. In addition, electromagnetic radiation-absorbing fillers offer the possibility of heating the shape-memory polymer by means of electromagnetic radiation for the purpose of programming them or triggering recovery processes (shape-memory effects). The same applies to inductively heatable fillers with respect to a heating by exposure in high-frequency, alternating magnetic fields. For the purposes mentioned above, advantageous fillers have, for example, a graphene structure, as is present, for example, in graphite, in carbon nanotubes (CNT), graphene flakes, or expanded graphite. Likewise, other particles may be used as fillers, for example magnetic and/or ferromagnetic particles, in particular from the group of Ni/Zn, iron oxide, and magnetite particles. So-called nanoclays, for example, may also be used as fillers, which may be formed, for example, on the basis of silicon nitride, silicon carbide, silicon oxide, zirconium oxide, and/or aluminum oxide. Other suitable fillers include oligomeric silsesquioxanes, the aforementioned graphite particles, graphenes and carbon nanotubes, synthetic fibers, in particular carbon fibers, glass fibers, or Kevlar fibers, as well as metal particles, combinations of such filler materials, of course, also being able to be used. It is further possible, in principle, to dye the shape-memory polymers of the splint element with the aid of suitable colorants and/or pigments, food colorants, in particular, having been proven to be particularly suitable, due to their excellent physiological compatibility. Moreover, it is, of course, conceivable that further additives known from plastics engineering are used, such as lubricants, softeners, antioxidants, UV stabilizers, dulling agents, antistatic agents, hydrolysis stabilizers, impact modifiers, and the like.

The chemical synthesis of the thermoplastic polyether polyurethanes according to the invention having both thermo-responsive and water-responsive shape-memory properties of the splint element may, in principle, take place according to methods known per se, for example according to the one-shot or prepolymer process, a purely exemplary method of synthesis for producing an example of a thermoplastic polyether polyurethane according to the invention having shape-memory properties being described below.

In an example:

Manufacturing a thermoplastic polyether polyurethane having both thermo-responsive and water-responsive shape-memory properties:

Hard segments: Polyurethane units, which have been obtained by polyaddition of a diisocyanate in the form of 4,4′-methylene diphenyl diisocyanate (4,4′-MDI) to a diol acting as a chain extender in the form of 1,4-butanediol (1,4-BD),
Soft segments: polyether units in the form of polypropylene glycol (PPG) having an average molar mass of 430 g/mol.

The thermoplastic polyether polyurethane having shape-memory properties is synthesized from the reaction of the polypropylene glycol (PPG) with 4,4′-methylene diphenyl diisocyanate (4,4′-MDI) and 1,4-butanediol (1,4-BD) in a molar ratio of PPG: 4,4′-MDI: 1,4-BD=1:2,17:2,16 according to the prepolymer process and contains the soft segments based on the polypropylene glycol units having an average molar mass of 430 g/mol. The hard segment share of the obtained polyether polyurethane is approximately 60 mass %, while the soft segment share is approximately 40 mass %, in relation to the total mass of the polyether polyurethane in each case.

The glass transition range of the soft segments determined by means of differential scanning calorimetry (DSC) was verified between approximately 45° C. and approximately 55° C. This result was confirmed by means of a dynamic mechanical analysis (DMA).

Sample bodies, on the one hand, and splint elements, on the other hand, were produced from the thermoplastic polyether polyurethane synthesized according to this example according of the manufacturing method according to the invention to verify both thermo-responsive and water-responsive shape-memory properties, the splint elements having been programmed from their manufacturing-induced permanent shape (corresponding to a setpoint dental arch model) into a temporary shape (according to an actual dental arch model), in that they were heated, by means of a thermomechanical treatment, to a temperature above the switching temperature of the thermoplastic polyether polyurethane having shape-memory properties (see above)—to a temperature of approximately 80° C. in this case—plastically deformed, and cooled to a temperature below the form-fixing temperature of the polyether polyurethane having shape-memory properties—to approximately 23° C. in this case—maintaining the deformation forces applied for this plastic deformation. The results obtained are explained below with reference to the drawings.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a diagram of temperature T (C), tensile force σ (Mpa), and strain ε (%) of the programmed thermoplastic polyether polyurethane having shape-memory properties over time t [min] while briefly heating a sample body multiple times to a temperature above the switching temperature—to just under 80° C. in this case—and cooling it to a temperature below the shape-fixing temperature of the soft or hard segments in the form of polypropylene glycol units for the purpose of determining the thermomechanical properties of the programmed polyether polyurethane having shape-memory properties;

FIG. 2 shows a sequence of photographic views of one of the programmed splint elements, in each case after a heating corresponding to one of the setup steps to the range of the switching temperature, these views illustrating the successive shape recovery of the splint element from it temporary shape into its permanent shape, for the purpose of verifying the thermo-responsive shape-memory properties of the thermoplastic polyether polyurethane;

FIG. 3 shows a sequence of photographic views of one of the programmed splint elements, in each case at different points in time during the immersion of the splint element in water at a temperature of approximately 37°, i.e., significantly below the switching temperature of the soft or switching segments of the thermoplastic polyether polyurethane in the form of polypropylene glycol units, for the purpose of verifying the water-responsive shape-memory properties of the thermoplastic polyether polyurethane; and

FIG. 4 shows, in each case, an enlarged photographic view of the splint element immersed in water at 37° C. according to FIG. 3, in its programmed temporary shape at the beginning of the immersion (“0 min” on the left), on the one hand, and after a 20-hour immersion in warm 37° C. water (“20 h” on the right), on the other hand.

### DETAILED DESCRIPTION

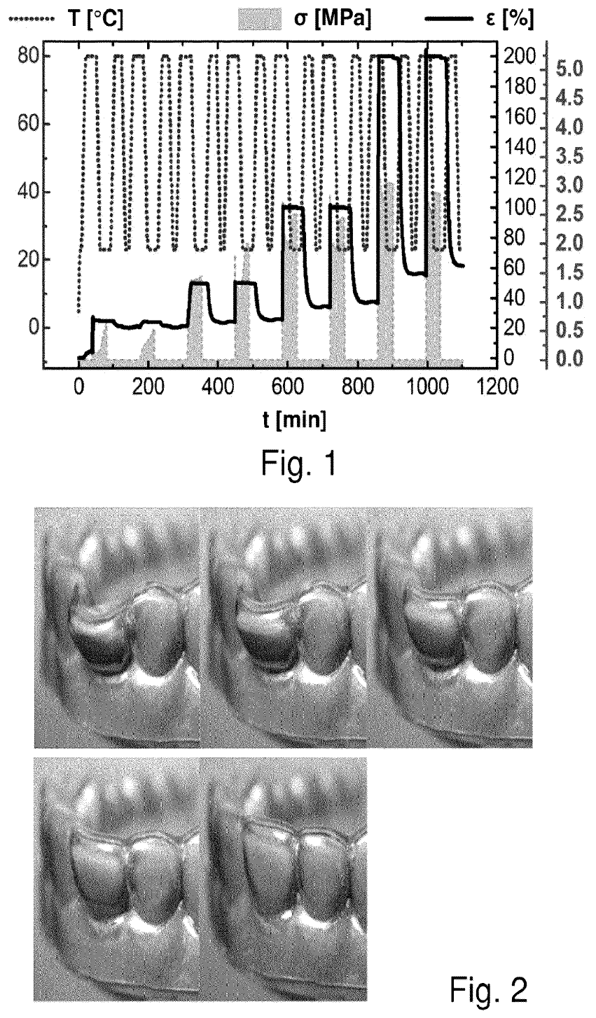

FIG. 1 is a diagram for characterizing the synthesized polyether polyurethane having shape-memory properties in relation to its thermo-mechanical properties. As is apparent from FIG. 1, the thermomechanical properties of the polyether polyurethane having shape-memory properties were, in turn, examined at approximately 23° C. and approximately 80° C., in that a sample body produced therefrom in the form of a tensile rod was elongated or stretched step by step, and the measuring points were each determined after an appropriate equilibrium period after each elongation step. Characteristics typical for shape-memory polymers are apparent, according to which an elongation at low temperatures below the switching temperature (here: approximately 23° C.) requires a high tensile stress, while the same elongation at high temperatures above the switching temperature (approximately 80° C. in this case) requires a correspondingly much lower tensile stress. However, the “cold” polyether polyurethane having shape-memory properties could be elongated or deformed to a much lesser extent under a predefined tensile stress than the “warm” polyether polyurethane having shape-memory properties under the same tensile stress.

A sequence of photographic views of a programmed splint element is depicted in FIG. 2, which was made from the synthesized polyether polyurethane having shape-memory properties, in each case after a heating corresponding to a particular setup step to a range of the switching temperature (just under 80° C. in this case). The effectuated successive shape recovery of the splint element from its temporary shape (upper left) to its permanent shape (lower right) is apparent.

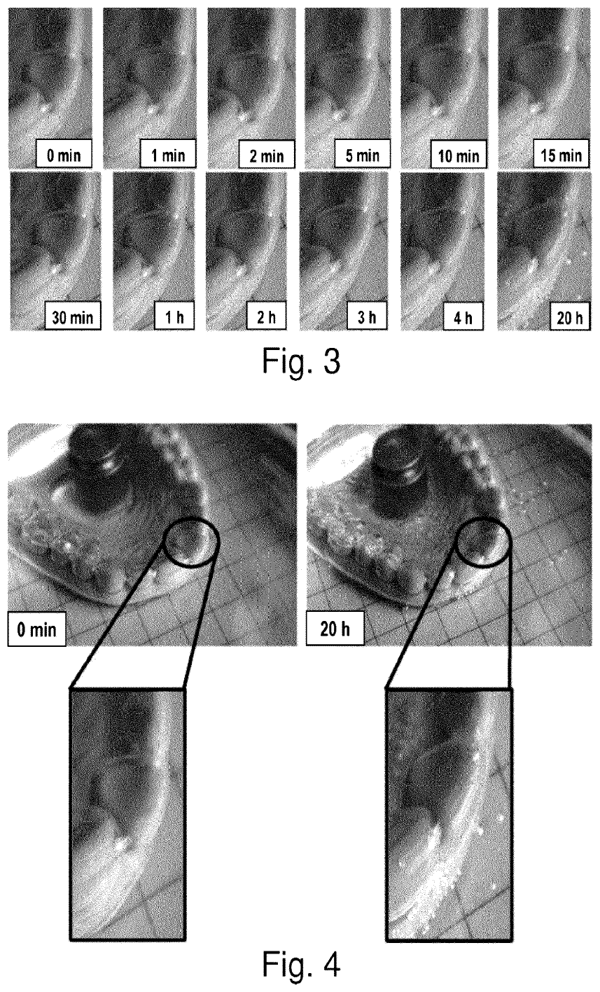

FIG. 3 shows a sequence of photographic views of a programmed splint element made from the synthesized polyether polyurethane having shape-memory properties, in each case at different points in time during the immersion of the splint element in water at a temperature of approximately 37°, i.e., significantly below the switching temperature of the soft or switching segments of the thermoplastic polyether polyurethane in the form of polypropylene glycol units. A more or less continuous shape recovery of the splint element from its temporary shape (upper left at 0 minutes) to its permanent shape (lower right at 20 hours) is apparent.

Finally, FIG. 4 shows enlarged photographic views of the splint element immersed in warm 37° C. water according to FIG. 3, in its programmed temporary shape at the beginning of the immersion (at 0 minutes on the left), on the one hand, and after a 20-hour immersion in warm 37° C. water (at 20 hours on the right), on the other hand. In this case as well, the rebound of the splint element is apparent—or, more specifically, a section thereof, which has been programmed to a malocclusion—from its temporary shape (left) to its permanent shape (right) as a result of a 20-hour contact with water.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An orthodontic teeth-straightener comprising:
at least one splint element, which contains at least one thermoplastic polyurethane having shape-memory properties, at least in regions, or is formed essentially entirely therefrom, the thermoplastic polyurethane having shape-memory properties being selected from a group of polyether polyurethanes and containing—hard segments containing polyurethane units which have been obtained by polyaddition of the isocyanate groups of at least one diisocyanate to a hydroxyl groups of at least one diol acting as a chain extender, forming urethane groups; and
soft segments which contain or are made entirely from polyether units in the form of at least one polyalkylene glycol, the polyether units being bonded to isocyanate end groups of the at least one diisocyanate of the hard segments, forming urethane groups with the hard segments,
wherein the thermoplastic polyether polyurethane are thermo-responsive and water-responsive.

2. The teeth-straightener according to claim 1, wherein the polyalkylene glycol of the polyether units of the soft segments of the thermoplastic polyether polyurethane is polyethylene glycol (PEG) and/or polypropylene glycol (PPG), and/or polytetramethylene ether glycol (PTMEG).

3. The teeth-straightener according to claim 1, wherein the polyether units of the soft segments of the thermoplastic polyether polyurethane have an average molar mass of at least 250 g/mol or at least 300 g/mol or at least 350 g/mol and/or no more than 2,000 g/mol or no more than 1,600 g/mol or no more than 1,200 g/mol.

4. The teeth-straightener according to claim 1, wherein the switching temperature of the thermoplastic polyether polyurethane corresponding to the glass transition temperature of the polyether units of the soft segments is more than 37° C. or at least 38° C. or at least 40° C. and/or no more than 100° C. or no more than 90° C. or no more than 80° C.

5. The teeth-straightener according to claim 1, wherein a share of the polyether units of the soft segments is between 10 mass % and 80 mass % or between 20 mass % and 70 mass %, or between 30 mass % and 60 mass % in relation to the total mass of the thermoplastic polyether polyurethane.

6. The teeth-straightener according to claim 1, wherein the at least one diisocyanate, from which the polyurethane units of the hard segments of the thermoplastic polyether polyurethane have been obtained, is selected from the group of aromatic, aliphatic or cycloaliphatic diisocyanates, or from the group of isomers or isomer mixtures of the methylene diphenyl diisocyanates (MDI), 1,6-hexamethylene diisocyanate (HDI), 4,4′-diisocyanato dicyclohexylmethane (H₁₂MDI), isomers or isomer mixtures of the toluene diisocyanates (TDI), 1,5-pentanodiisocyanate (PDI), isophorone diisocyanate (IPDI), naphthalene diisocyanate (NDI), or polymeric diphenylmethane diisocyanate (PMDI), including mixtures thereof.

7. The teeth-straightener according to claim 1, wherein the at least one diol acting as a chain extender, from which the polyurethane units of the hard segments of the thermoplastic polyether polyurethane have been obtained, is selected from the group of alkane diols, in particular from the group of ethanediol (ethylene glycol), 1,3-propanediol (propylene glycol), 1,4-butanediol, 1,5-pentanediol, 3-methyl-1,5-pentanediol, 1,6-hexanediol, 1,7-heptanediol, 1,8-octanediol, 2-methyl-1,8-octanediol, 1,9-nonanediol, 1,10-decanediol, 1,11-undecanediol, or 1,12-dodecanediol, including mixtures thereof.

8. The teeth-straightener according to claim 1, wherein the thermoplastic polyether polyurethane contains at least one additive, which is selected from the group of biocompatible oils; electromagnetic radiation-absorbing fillers; inductively heatable fillers; colorants and pigments; or reinforcing fibers.

9. A method for manufacturing a splint element of an orthodontic teeth-straightener according to claim 1, the method comprising:
(a) providing at least one film, which contains at least one thermoplastic polyurethane having shape-memory properties, at least in regions, or is formed essentially entirely therefrom, the thermoplastic polyurethane comprising shape-memory properties being selected from the group of polyether polyurethanes and comprising hard segments containing polyurethane units that have been obtained by polyaddition of the isocyanate groups of at least one diisocyanate to the hydroxyl groups of at least one diol acting as a chain extender, forming urethane groups, and comprising soft segments which contain or are made entirely from polyether units in the form of at least one polyalkylene glycol, the polyether units being bonded to isocyanate end groups of the at least one diisocyanate of the hard segments, forming urethane groups with the hard segments, the thermoplastic polyether polyurethane being thermo-responsive as well as water-responsive;
(b) overmolding the at least one film onto a setpoint dental arch model, forming a splint element, which is in a permanent shape of the thermoplastic polyether polyurethane having shape-memory properties;
(c) heating the splint element according to step (b) at least to the switching temperature of the thermoplastic polyether polyurethane having shape-memory properties and overmolding the splint element onto an actual dental arch model or onto a human dental arch, after which the splint element is cooled in a temporary shape at least to the form-fixing temperature of the thermoplastic polyether polyurethane, or immersing the splint element according to step (b) in water or in an aqueous solution and overmolding the splint element onto an actual dental arch model or onto a human dental arch, after which the splint element is dried in a temporary shape; and
(d) removing the splint element, which is in the temporary shape, from the actual dental arch model or from the human dental arch.

10. The method according to claim 9, wherein, according to step (a), at least one film is used which contains at least one thermoplastic polyurethane having shape-memory properties, at least in regions, or is made essentially entirely therefrom.

11. A method for manufacturing a splint element of an orthodontic teeth-straightener according to claim 1, the method comprising:
(a) generating a three-dimensional model of the splint element according to a setpoint dental arch model;
(b) feeding the three-dimensional model of the splint element into a 3D printer;
(c) fused deposition modeling the splint element in a permanent shape with the aid of the 3D printer, using at least one printing filament or granulate made from a thermoplastic polymer material which contains at least one thermoplastic polyurethane having shape-memory properties or is formed essentially entirely therefrom, the thermoplastic polyurethane having shape-memory properties being selected from the group of polyether polyurethanes and comprising hard segments containing polyurethane units which have been obtained by polyaddition of the isocyanate groups of at least one diisocyanate to the hydroxyl groups of at least one diol acting as a chain extender, forming urethane groups and comprising soft segments which contain or are made entirely from polyether units in the form of at least one polyalkylene glycol, the polyether units being bonded to isocyanate end groups of the at least one diisocyanate of the hard segments, forming urethane groups with the hard segments,
the thermoplastic polyether polyurethane being thermo-responsive as well as water-responsive;
(d) heating the splint element according to step (c) at least to a switching temperature of the thermoplastic polyether polyurethane having shape-memory properties and overmolding the splint element onto an actual dental arch model or onto a human dental arch, after which the splint element is cooled in a temporary shape at least to the shape-fixing temperature of the thermoplastic polyether polyurethane; or—Immersing the splint element according to step (c) in water or into an aqueous solution and overmolding the splint element onto an actual dental arch model or onto a human dental arch, after which the splint element is dried in a temporary shape; and
(e) removing the splint element, which is in the temporary shape, from the actual dental arch model or from the human dental arch.

12. The method according to claim 11, wherein, according to step (a), a printing filament or granulate is used which contains at least one thermoplastic polyurethane having shape-memory properties or is made essentially entirely therefrom.

13. The method according to claim 12, wherein the polyalkylene glycol of the polyether units of the soft segments of the thermoplastic polyether polyurethane is polyethylene glycol (PEG) and/or polypropylene glycol (PPG), and/or polytetramethylene ether glycol (PTMEG).
